(19) United States
(12) Patent Application Publication
(10) Pub. No.: US 2015/0375717 A1
(43) Pub. Date: Dec. 31, 2015

(54) VARIABLE HEADLIGHT WASHER SPRAY APPARATUS AND METHOD DEPENDENT ON OUTSIDE TEMPERATURE

(71) Applicants: Thomas G. Kracker, Marysville, OH (US); John A. Horan, Marysville, OH (US); Michael T. Binfet, Bellefontaine, OH (US)

(72) Inventors: Thomas G. Kracker, Marysville, OH (US); John A. Horan, Marysville, OH (US); Michael T. Binfet, Bellefontaine, OH (US)

(73) Assignee: HONDA MOTOR CO., LTD., Raymond, OH (US)

(21) Appl. No.: 14/318,041

(22) Filed: Jun. 27, 2014

(51) Int. Cl. B60S 1/48; B60S 1/66; B60S 1/52

(52) U.S. Cl. CPC B60S 1/481; B60S 1/528; B60S 1/66

(57) ABSTRACT

A temperature-dependent spray assembly for a headlight and associated method of spray washing a headlight are provided. The spray assembly includes a nozzle assembly having an opening directed toward a headlight lens surface. A sensor monitors an outdoor temperature. A controller is in operative communication with the sensor and the nozzle assembly, and the controller provides a signal indicative of one of (i) a temperature at or above a predetermined temperature and (ii) a temperature below the predetermined temperature whereby the nozzle assembly is operated in a first manner at or above the predetermined temperature and in a different, second manner below the predetermined temperature.

### BACKGROUND

The present disclosure relates to a system or apparatus, and an associated method, providing washer spray to a vehicle headlight, and more particularly to an apparatus and method for providing variable spray times dependent on outside temperatures.

Many vehicles on the market, primarily in Europe but also in the US and other vehicle markets, apply headlight washers to keep a vehicle headlight lens clean. European regulations, for example, state that headlight washers must be applied to the lamps with a light source greater than 2000 lumens. Typically, the spray patterns are optimized during layout check and testing. Each supplier has its own method of creating spray patterns. For example, the assignee of the present disclosure uses spring-loaded nozzles mounted, for example, in the bumpers with a plastic cap to conceal the nozzle in the bumper.

Tank size and cleaning performance are typically optimized for cleaning at room temperature, or at temperatures above freezing. At colder temperatures, however, the cleaning performance can be less than desired depending on the type of spray timing. For example, one known apparatus and method of spray provides a single long pulse (i.e., approximately 1200 milliseconds (ms) spray time), while another apparatus and method of spray uses two shorter pulses where each spray pulse (i.e., approximately 800 ms spray time) is separated or divided a pause on the order of approximately 4000 ms. It is also recognized that every spray has some rise time, spray time, and fall time, which are inherent with a spring-loaded spray washer nozzle. Static nozzles would just have spray time.

Depending on the environment, the effectiveness of the headlight washer spray will vary. For example, during the winter and in association with freezing temperatures, a short pulse of the wash spray may partially freeze and thus a second short pulse may be ineffective in removing salt/snow/ice. During the summer, and in association with warmer temperatures, a single pulse may not be sufficient to adequately loosen dirt/mud.

Accordingly, a need exists to effectively alter the operation of the headlight wash spray depending on outside environmental conditions.

### SUMMARY

A temperature-dependent spray assembly for a headlight and associated method of spray washing a headlight are provided.

The spray assembly includes a nozzle assembly having an opening directed toward a headlight lens surface. A sensor monitors an outdoor temperature. A controller is in operative communication with the sensor and the nozzle assembly, and the controller provides a signal indicative of one of (i) a temperature at or above a predetermined temperature and (ii) a temperature below the predetermined temperature whereby the nozzle assembly is operated in a first manner at or above the predetermined temperature and in a different, second manner below the predetermined temperature.

The first manner includes at least time-spaced first and second spray pulses.

The second manner is a single spray pulse.

The single spray pulse has a longer time period than the at least one of the first and second spray pulses, and in one preferred arrangement a longer time period than each of the first and second spray pulses.

The first and second spray pulses have a time period less than an off time period between the first and second spray pulses.

The predetermined temperature is at 32° F. or above.

A method of operating a spray assembly for a headlight includes providing a nozzle assembly having an opening directed toward a headlight lens surface. The method further includes monitoring an outdoor temperature with a sensor. Still further, the method includes controlling the nozzle assembly in response to the sensed outdoor temperature and operating the nozzle assembly in a first manner at or above the predetermined temperature and in a different, second manner below the predetermined temperature.

The first manner operating step includes pulsing the nozzle assembly at least first and second times, and the second manner operating step includes pulsing the nozzle assembly a single time.

The single pulsing step is longer than at least one of the first and second pulsing steps, and in one preferred arrangement longer than each of the first and second pulsing steps.

The method includes setting the predetermined temperature at 32° F. or above.

One benefit is the ability to effectively wash the lens a headlight.

Another advantage resides in the ability to improve the cleaning capability of the headlight washer spray without altering existing components.

Still another benefit is associated with the optimized cleaning in response to ambient temperature conditions.

Yet another advantage results from the varied manner of washing the headlight without interaction by the vehicle user.

Still other benefits and advantages of the present disclosure will become more apparent from reading and understanding the following detailed description.

### BRIEF DESCRIPTION OF THE DRAWINGS

FIG. 1 is a partial cross-sectional view taken through a bumper of a vehicle with a headlight washer assembly in an operative position.

FIG. 2 is a graphical representation of a single pulse of spray wash on the headlight lens.

FIG. 3 is a graphical representation of repeated pulses of spray wash on the headlight lens.

FIG. 4 is a flow chart representative of the steps associated with the variable headlight washer spray times in response to a sensed outside temperature.

### DETAILED DESCRIPTION

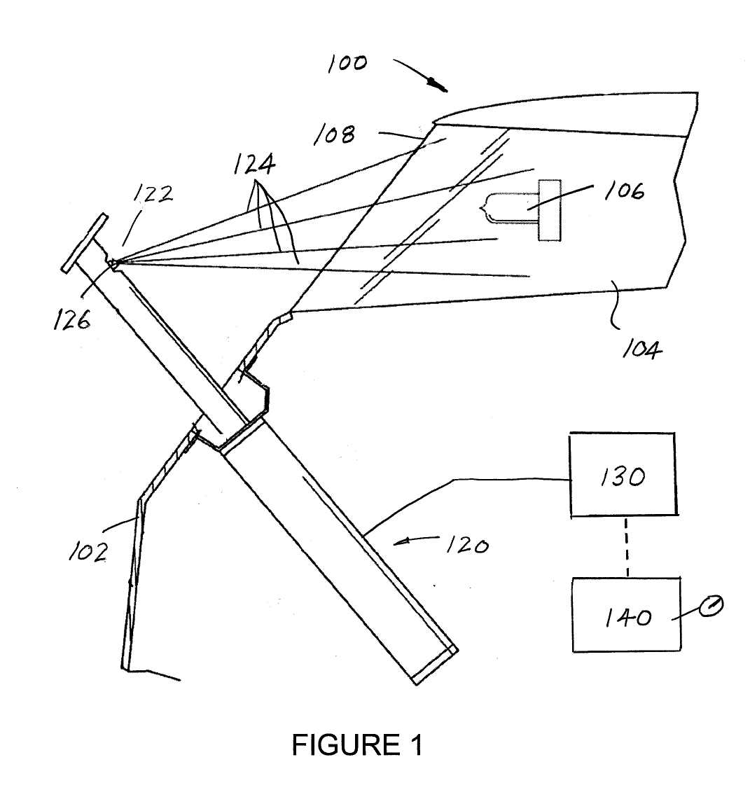

Turning to FIG. 1 there is shown a front portion 100 of a vehicle, namely a hood portion, and a bumper 102 (or a bumper skin or layer of material that shrouds the the actual functional bumper of the vehicle). As will be appreciated by those skilled in the art, the bumper skin provides a more aesthetic surface and conceals the functional bumper, although the term bumper is intended to refer to a forward portion of the vehicle and can include bumper skins, fenders, grills, hoods, etc., and is not intended to unduly limit the present disclosure.

Mounted in the front of the vehicle are a pair of headlights 104 (only one of which is illustrated in FIG. 1). A light source 106 is received in the headlight 104 and a reflector directs light in a desired manner and direction typically forward of the vehicle in a manner well known in the art so that further discussion of its operation is unnecessary. A light transmissive lens or cover 108 is received over the light source 106 of the headlight 104.

As particularly illustrated in FIG. 1, a headlight washer assembly 120 is shown in an operative position where a nozzle 122 thereof emits a spray 124 of washer or cleaning fluid toward the lens 108 of the headlight 104. The headlight washer assembly 120 is shown as being mounted below the headlight, although it will be recognized that the assembly could also be mounted above or to the side of the headlight without departing from the scope and intent of the present disclosure. Likewise, the nozzle 122 is part of a telescoping or selectively retractable washer assembly in FIG. 1 (for example as more completely shown and described in commonly owned US 2014/0008460A1) and thus in addition to the deployed or operative position shown in FIG. 1, the washer assembly 120 has a storage position (not shown) where the nozzle is retracted. Further, other known types of washer assemblies exist and can also be used in accordance with the present disclosure.

When disposed in the operative position, the nozzle 122 receives pressurized cleaning or wash fluid and directs the wash fluid through at least one opening 126 toward the lens 108. A valve (not shown) selectively opens to allow the pressurized wash fluid to reach the headlight 104, and similarly closes to preclude further wash spray from being directed against the headlight lens 108.

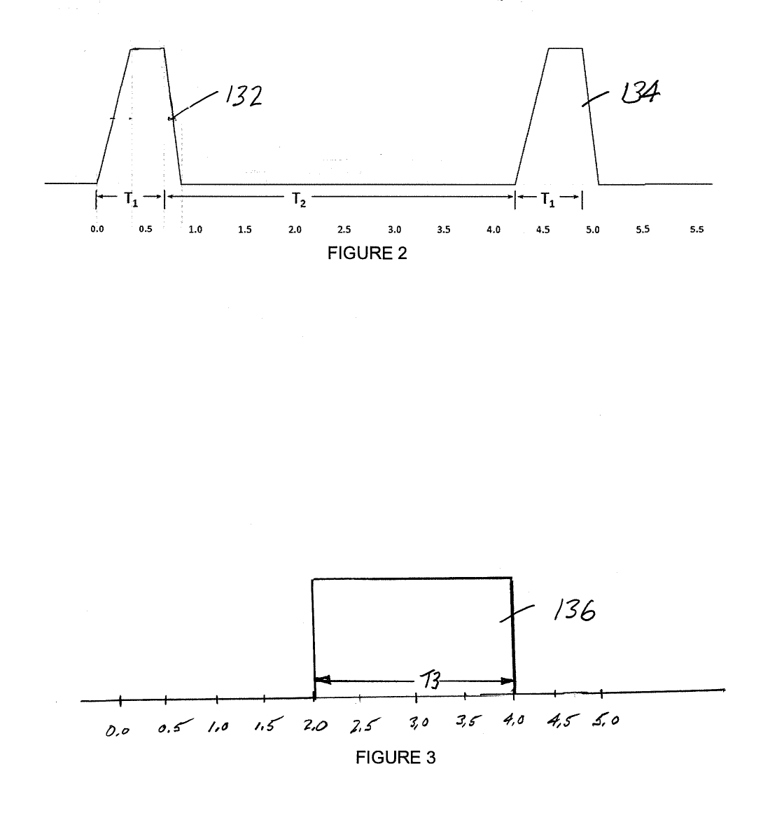

A controller 130 is operatively associated with the washer assembly 120. The controller includes a memory that stores operational information, e.g., pump on/off, valve open/closed, stored programs of operation, etc. in order to control the supply of wash fluid from a reservoir (not shown) to a pump (not shown), and opens/closes a valve to direct the spray or shut-off wash fluid to the nozzle opening(s) as desired. As noted above in the Background, one type of wash assembly that is generally known uses multiple, shorter duration pulses 132, 134 of wash fluid where the pulses (T1) are spaced apart by a preselected time period (T2) (see FIG. 2). For example, one spray wash assembly that uses multiple, short pulses uses two shorter pulses where each spray pulse 132, 134 (i.e., T1 is approximately 800 ms spray time) is separated or divided by a pause or off-time T2 on the order of approximately 4000 ms. One skilled in the art will recognize that still other spray pulse times separated by a greater or shorter time period can be used, or in other arrangements the individual pulses 132, 134 of the multiple pulse arrangement may vary (different pressure, different duration, different number of pulses, etc.).

Alternatively, other spray wash assemblies direct a single long pulse 136 (i.e., T3 is approximately 1200 milliseconds (ms) spray time) against the surface of the lens (see FIG. 3). Of course other periods of spray time may be used in the art.

Dust, dirt, and/or mud builds up on the lens during warmer weather and likewise salt/snow/ice builds up during colder weather. Experience has shown that the multiple pulse and single pulse spray wash assemblies have different effectiveness against these different conditions, and moreover that the temperature also plays a factor in removing either dust, dirt, and/or mud during warmer weather and in removing slat/snow/ice in colder weather. Generally speaking, in warmer weather the multiple or two pulse 132, 134 method would be used and in colder weather the single elongated pulse 136 method would be used. The theory is that in the warmer summer months, for example, the first pulse 132 will cover the headlight lens and soak in, and then the second spray pulse 134 washes away any loosened dust/dirt/mud. In the colder winter months, the single pulse 136 method is generally found preferable.

In the winter, if the multiple pulse arrangement is used, the first pulse 132 of spray wash from the assembly has an increased chance of at least partially freezing before really penetrating. As a result, the second pulse spray 134 is deemed less effective in washing away the buildup on the headlight lens. Likewise, in the summer, the single pulse 136 arrangement may not sufficiently penetrate or soak in and thus only some of the dust/dirt/mud may be removed.

The present disclosure addresses the situation by providing for variable operation of the spray wash assembly. More specifically, a sensor 140 is provided as a part of the spray wash assembly 120. The sensor 140 monitors the outside temperature and provides a suitable signal to the controller 130. Stored in the controller 130 is a threshold temperature at which the operation, mode, or manner of the spray wash assembly 120 can be changed. For instance, a predetermined threshold is selected (e.g., 32° F.) and the operation of the spray wash assembly 120 at or above the threshold temperature operates the spray wash assembly in a first mode or manner that includes multiple spray pulses (e.g., first and second spray pulses 132, 134). On the other hand, if the sensor 140 provides a signal indicative of the environment being below the threshold temperature, then a single pulse 136 of longer duration is used. Again, the number of pulses in the multiple pulse mode can be varied (different length of time, different pressure, different number of pulses, etc.), and likewise the single pulse mode can also be varied (different length of time, different pressure, etc.).

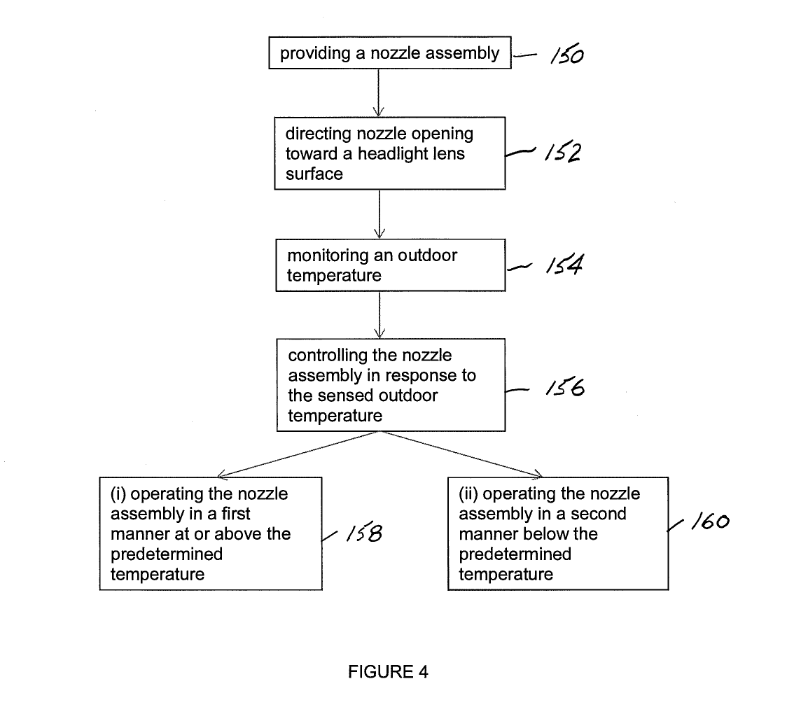

Shown in FIG. 4 is a representative operational flow chart. In a first step 150, a nozzle assembly is provided. Directing 152 a nozzle opening toward a headlight lens is provided, and a sensor is provided at step 154 to monitor the outside temperature. A signal from the sensor is communicated to a controller and the controller then determines a mode of operation of the nozzle in step 156. For example, in step 158, plural pulses of wash fluid are directed to the headlight lens 108, while in step 160, an elongated, single pulse is directed to the lens of the headlight.

Still other variations could be used, and the present disclosure should not be construed as being limited to the particular described examples.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

It is claimed:

1. A temperature-dependent spray assembly for a headlight comprising:
a nozzle assembly having an opening directed toward a headlight lens surface;
a sensor for monitoring an outdoor temperature; and
a controller in operative communication with the sensor and the nozzle assembly, the controller providing a signal indicative of one of (i) a temperature at or above a predetermined temperature and (ii) a temperature below the predetermined temperature whereby the nozzle assembly is operated in a first manner at or above the predetermined temperature and in a different, second manner below the predetermined temperature.

2. The temperature-dependent spray assembly of claim 1 wherein the first manner includes at least time-spaced first and second spray pulses.

3. The temperature-dependent spray assembly of claim 2 wherein the second manner is a single spray pulse.

4. The temperature-dependent spray assembly of claim 3 wherein the single spray pulse has a longer time period than the at least one of the first and second spray pulses.

5. The temperature-dependent spray assembly of claim 3 wherein the single spray pulse has a longer time period than each of the first and second spray pulses.

6. The temperature-dependent spray assembly of claim 1 wherein the predetermined temperature is at 32° F. or above.

7. The temperature-dependent spray assembly of claim 6 wherein the first manner includes at least time-spaced first and second spray pulses.

8. The temperature-dependent spray assembly of claim 7 wherein the second manner includes a single spray pulse.

9. The temperature-dependent spray assembly of claim 1 wherein the first and second spray pulses have about the same time period.

10. The temperature-dependent spray assembly of claim 1 wherein the first and second spray pulses have a time period less than an off time period between the first and second spray pulses.

11. A method of operating a spray assembly for a headlight comprising:
providing a nozzle assembly having an opening directed toward a headlight lens surface;
including a sensor for monitoring an outdoor temperature; and
controlling the nozzle assembly in response to the sensed outdoor temperature, and operating the nozzle assembly in a first manner at or above the predetermined temperature and in a different, second manner below the predetermined temperature.

12. The headlight spray assembly operating method of claim 11 wherein the first manner operating step includes pulsing the nozzle assembly at least first and second times.

13. The headlight spray assembly operating method of claim 12 wherein the second manner operating step includes pulsing the nozzle assembly a single time.

14. The headlight spray assembly operating method of claim 13 wherein the single pulsing step is longer than at least one of the first and second pulsing steps.

15. The headlight spray assembly operating method of claim 13 wherein the single pulsing step is longer than each of the first and second pulsing steps.

16. The headlight spray assembly operating method of claim 11 includes setting the predetermined temperature at 32° F. or above.

17. The headlight spray assembly operating method of claim 16 wherein the first manner includes pulsing at least first and second times.

18. The headlight spray assembly operating method of claim 17 wherein the second manner pulsing a single time.

19. The headlight spray assembly operating method of claim 11 wherein first and second pulsing steps are about the same time period.

20. The headlight spray assembly operating method of claim 11 wherein the first and second pulsing steps have a time period less than an off time period between the first and second pulsing steps.
